(19) United States
(12) Patent Application Publication
(10) Pub. No.: US 2016/0063110 A1
(43) Pub. Date: Mar. 3, 2016

(54) USER INTERFACE FOR GENERATING SEARCH QUERIES

(71) Applicants: Matthew David Shoup, San Jose, CA (US); Kathleen Susan So, Oakland, CA (US)

(72) Inventors: Matthew David Shoup, San Jose, CA (US); Kathleen Susan So, Oakland, CA (US)

(21) Appl. No.: 14/582,103

(22) Filed: Dec. 23, 2014

Related U.S. Application Data
(60) Provisional application No. 62/044,167, filed on Aug. 29, 2014.

(51) Int. Cl. G06F 17/30; G06F 3/0484; G06F 3/0481

(52) U.S. Cl. CPC G06F 17/30864; G06F 17/30678; G06F 3/04817; G06F 3/04842; G06F 17/30985; G06F 17/30454; G06F 17/30705

(57) ABSTRACT

Techniques for generating a search query via a user interface are described. According to various embodiments, a specific visual configuration of selected icons includes one or more distinct groups of selected icons. A group search query string is generated for each of the distinct groups, each group search query string including search query terms associated with the one or more selected icons in the respective group and further including a first type of boolean search operator between pairs of the search query terms included in the respective group search query string. A complete search query string is generated that includes each of the group search query strings and further includes a second type of boolean search operator between pairs of the group search query strings included in the complete search query string.

### CROSS-REFERENCE TO RELATED APPLICATIONS

This application claims the priority benefit of U.S. Provisional Application No. 62/044,167, filed on Aug. 29, 2014, which is incorporated herein by reference.

### TECHNICAL FIELD

The present application relates generally to data processing systems and, in one specific example, to techniques for generating a search query via a user interface.

### BACKGROUND

Online social network services such as LinkedIn® are becoming increasingly popular, with many such websites boasting millions of active members. Each member of the online social network service is able to upload an editable member profile page to the online social network service. The member profile page may include various information about the member, such as the member's biographical information, photographs of the member, and information describing the member's employment history, education history, skills, experience, activities, and the like. Such member profile pages of the networking website are viewable by, for example, other members of the online social network service. Moreover, the LinkedIn® online social network service provides a search feature that allows users (e.g., recruiters) to specify search query terms (e.g., schools, skills, companies, etc.) in order to search for members of the online social network service having attributes matching the search query terms.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the invention;

FIG. 2 is a block diagram of an example system, according to various embodiments;

FIG. 3 illustrates an example portion of a user interface, according to various embodiments;

FIG. 4 illustrates an example portion of a user interface, according to various embodiments;

FIG. 5 illustrates an example portion of a user interface, according to various embodiments;

FIG. 6 illustrates an example portion of a user interface, according to various embodiments;

FIG. 7 is a flowchart illustrating an example method, according to various embodiments;

FIG. 8 is a flowchart illustrating an example method, according to various embodiments;

FIG. 9 is a flowchart illustrating an example method, according to various embodiments;

FIG. 10 is a flowchart illustrating an example method, according to various embodiments;

FIG. 11 is a flowchart illustrating an example method, according to various embodiments;

FIG. 12 illustrates an example mobile device, according to various embodiments; and

FIG. 13 is a diagrammatic representation of a machine in the example form of a computer system within which a set of instructions, for causing the machine to perform any one or more of the methodologies discussed herein, may be executed

### DETAILED DESCRIPTION

Example methods and systems for generating a search query via a user interface are described. In the following description, for purposes of explanation, numerous specific details are set forth in order to provide a thorough understanding of example embodiments. It will be evident, however, to one skilled in the art that the present invention may be practiced without these specific details.

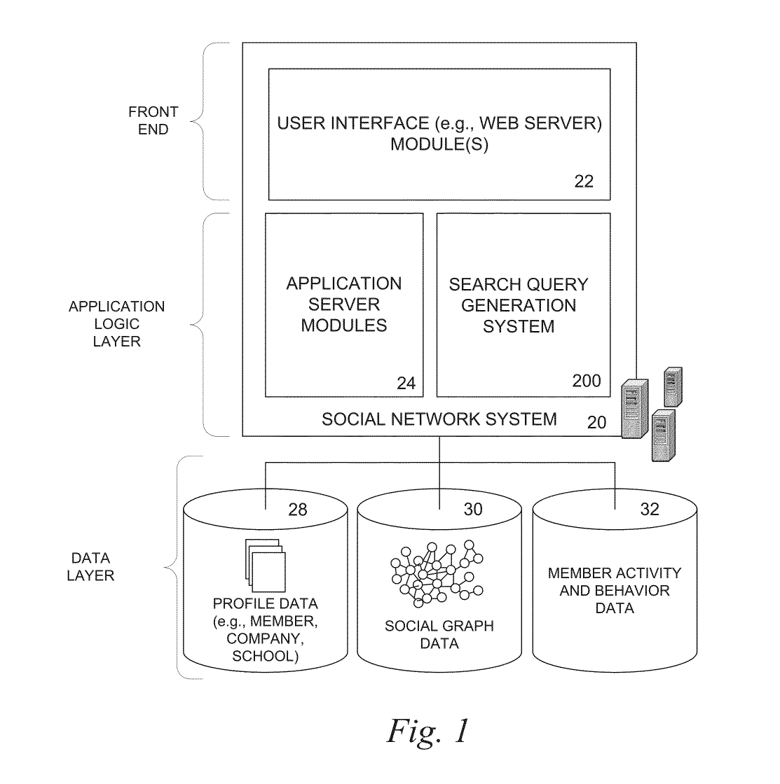

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

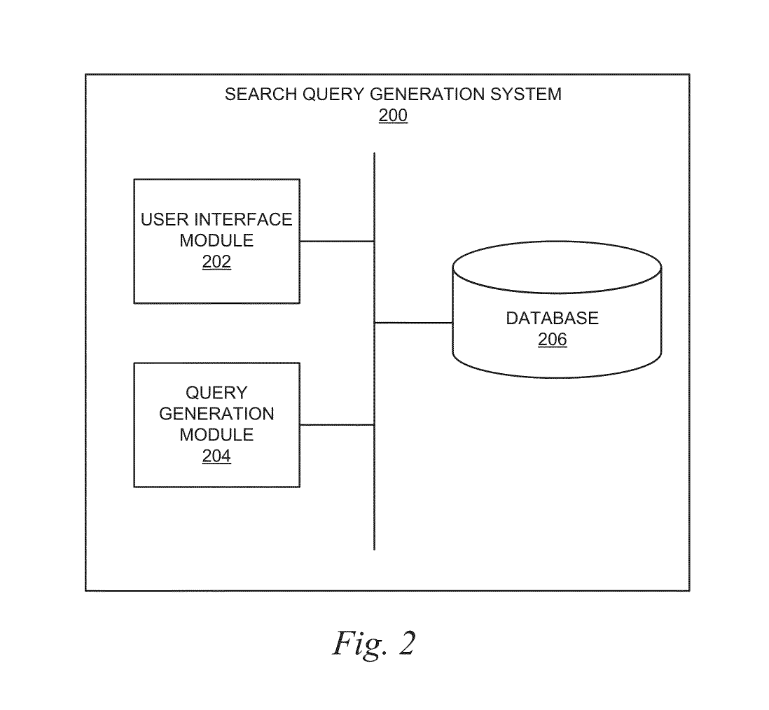

With some embodiments, the social network system 20 includes what is generally referred to herein as a search query generation system 200. The search query generation system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, a search query generation system 200 includes a user interface module 202, a query generation module 204, and a database 206. The modules of the search query generation system 200 may be implemented on or executed by a single device such as a search query generation device, or on separate devices interconnected via a network. The aforementioned search query generation device may be, for example, one or more client machines or application servers. The operation of each of the aforementioned modules of the search query generation system 200 will now be described in greater detail in conjunction with the figures.

According to various example embodiments described herein, the search query generation system 200 is configured to enable a user to generate search queries in an easy, efficient, fun, and intuitive manner, via a user-friendly interface. For example, in order to conduct a search, a user must conventionally enter a series of search query terms and Boolean logic operators (e.g., AND, OR, NOT, etc.) into a search bar of a search engine. This can become cumbersome, especially with search queries that involve a large number of terms and/or a large number of Boolean logic operators. Moreover, the user may be forced to re-enter the search query every time they visit a search engine and conduct a search.

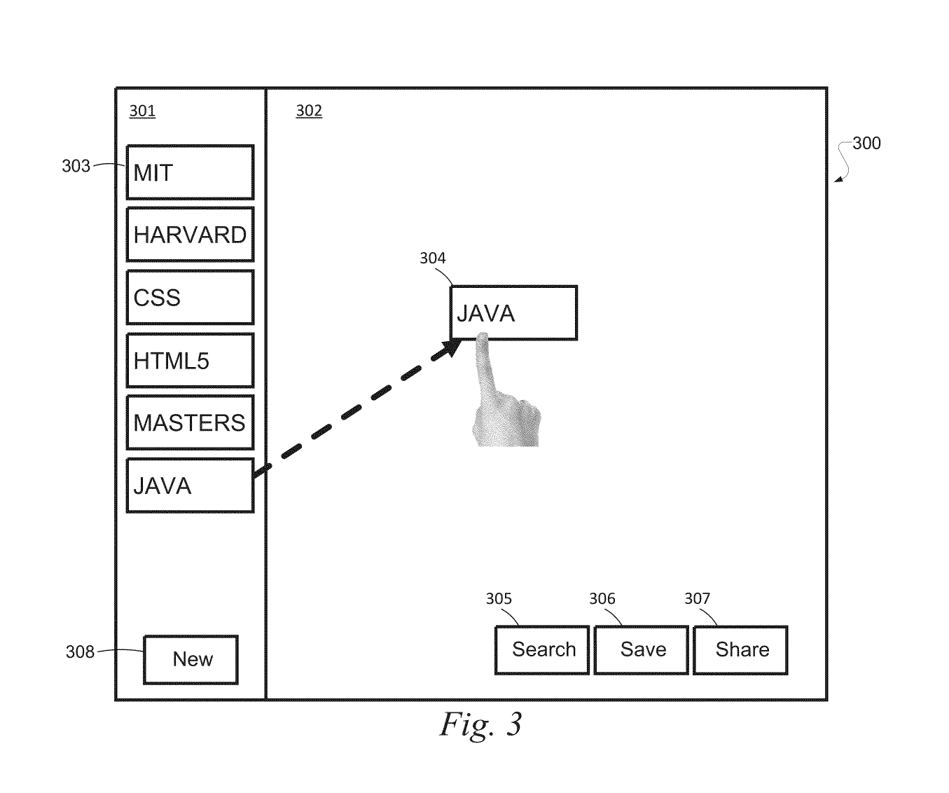

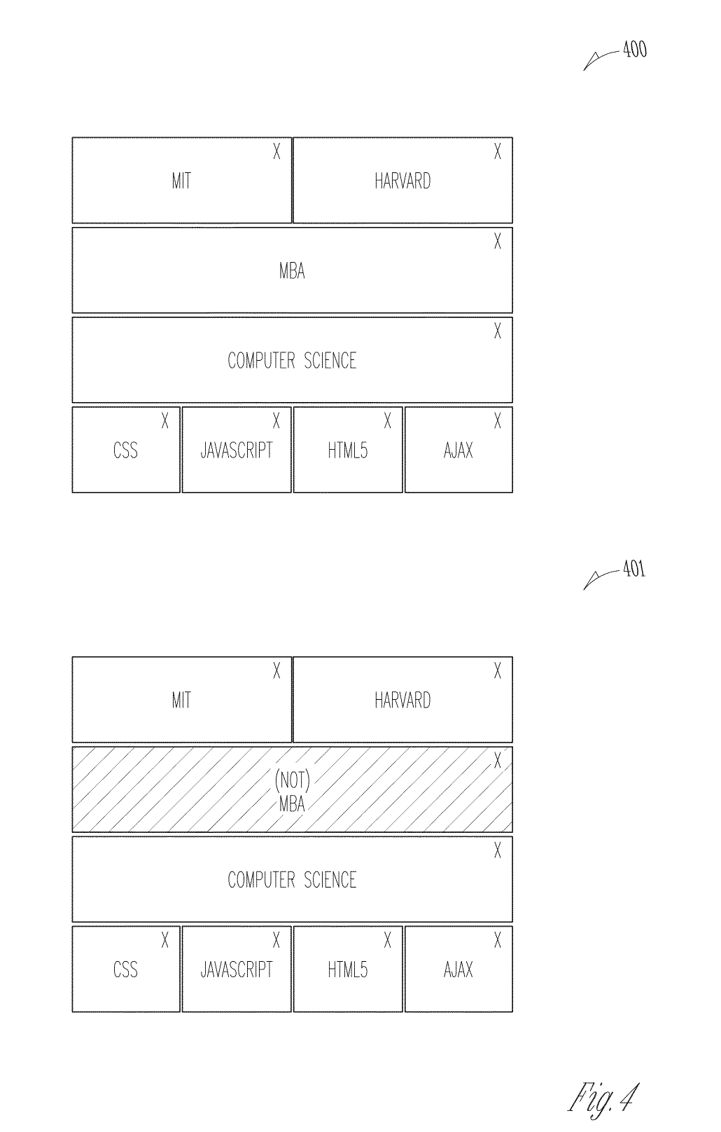

Accordingly, as described herein, the search query generation system 200 is configured to display a number of icons that are each associated with possible search query terms that the user may wish to use. For example, each of the icons may correspond to frequently used search query terms, such as individual words or attribute-value pairs. For example, the search query generation system 200 may display the user interface 300 illustrated in FIG. 3 that includes a first window 301 and a second window 302. The first window 301 includes a plurality of icons 303 corresponding to frequently used search query terms, such as “MIT” and “Harvard”, etc. The user may drag relevant icons from the first window 301 to the second window 302. In particular, the user may drag and drop the icons into a particular visual configuration including various lines (also referred to herein as groups or sets), as illustrated in user interface 400 in FIG. 4, where icons may be placed next to each other in both the horizontal and vertical direction.

According to various embodiments, terms associated with icons on a given line (e.g., placed next to each other in a horizontal direction on a horizontal line) may be converted into a search query string having OR operators between each of the relevant terms. Moreover, a plurality of the aforementioned lines (e.g., horizontal lines that are arranged next to each other in a vertical direction) may be treated as a search query string having AND operators between each of the lines. For example, with reference to the visual configuration 400 illustrated in FIG. 4, since the terms MIT and Harvard are next to each other in a horizontal direction on a given horizontal line, the search query generation system 200 will generate a search query string (“MIT” OR “Harvard”) associated with the first line. Similarly, since the terms CSS, JavaScript, HTML5, and Ajax are placed next to each other on the fourth horizontal line, the search query generation system 200 will generate a search query string (“CSS” OR “JavaScript” OR “HTML5” OR “AJAX”) associated with the fourth line. Moreover, the system 200 will associate all the relevant search strings on each line with AND Boolean logic operators in order to generate a complete search query string. For example, for the visual configuration 400 illustrated in FIG. 4, the search query generation system 200 may generate the search string: (“MIT” OR “Harvard”) AND (“MBA”) AND (“COMPUTER SCIENCE”) AND (“CSS” OR “JavaScript” OR “HTML5” OR “AJAX”). In the visual configuration 400 illustrated in FIG. 4, the user can also select an icon (e.g., by right clicking it) in order to apply a negative (NOT) Boolean logic operator to it. In such case, the color or shading of the icon may be changed (e.g., to red), as seen in the visual configuration 401. Thus, if the MBA search term is selected in this manner, the complete search query string associated with the visual arrangement 401 illustrated in FIG. 4 will be changed to: (“MIT” OR “Harvard”) AND (NOT(“MBA”)) AND (“COMPUTER SCIENCE”) AND (“CSS” OR “JavaScript” OR “HTML5” OR “AJAX”).

Thus, the user may easily manipulate icons in order to generate a complex search query string. The user may also click on the “X” button on any icon to remove that icon from the appropriate visual arrangement. Once the user has manipulated the icons into the appropriate arrangement, the user may select the search button 305 in FIG. 3 in order to automatically generate the appropriate complete search query string and automatically insert it into a search bar of a search engine or have it processed immediately by the database, in order to perform a search based on the complete search query string. In some embodiments, the complete search query string may be generated in near real-time and displayed in the search bar while or shortly after the user manipulates various icons into and out of the visual arrangement.

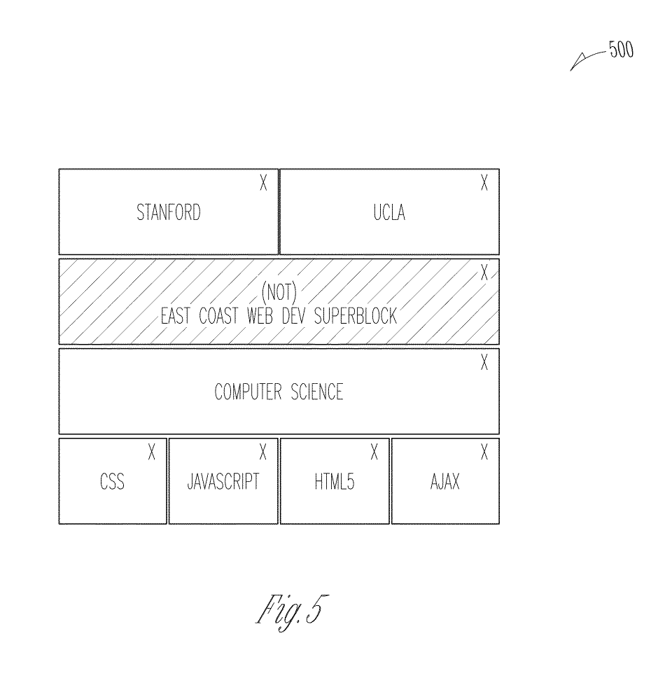

In some embodiments, by selecting the save button 306 in FIG. 3, the current visual arrangement may be saved as a “superblock” or “search icon block” for reuse. For example, the superblock may be displayed in the first window of 301 in FIG. 3 and manipulated as any of the other icons 303. For example, suppose the visual arrangement 401 in FIG. 4 is saved as a “East Coast Webdev Superblock” search block. FIG. 5 illustrates another visual arrangement 500 of icons where the user has dragged not only icons associated with basic terms such as “Stanford” or “UCLA”, but the user has also dragged the entire “East Coast Webdev Superblock” superblock. Accordingly, the search query string associated with the “East Coast Webdev Superblock” search block may be utilized to generate greater search query strings, consistent with the techniques described above. For example, based on the visual arrangement 500 illustrated in FIG. 5, the search query generation system 200 will generate a search screen corresponding to: (“Stanford” OR “UCLA”) AND (NOT((“MIT” OR “Harvard”) AND (NOT(“MBA”)) AND (“COMPUTER SCIENCE”) AND (“CSS” OR “JavaScript” OR “HTML5” OR AJAX”))) AND (“COMPUTER SCIENCE”) AND (“CSS” OR “JavaScript” OR “HTML5” OR “AJAX”).

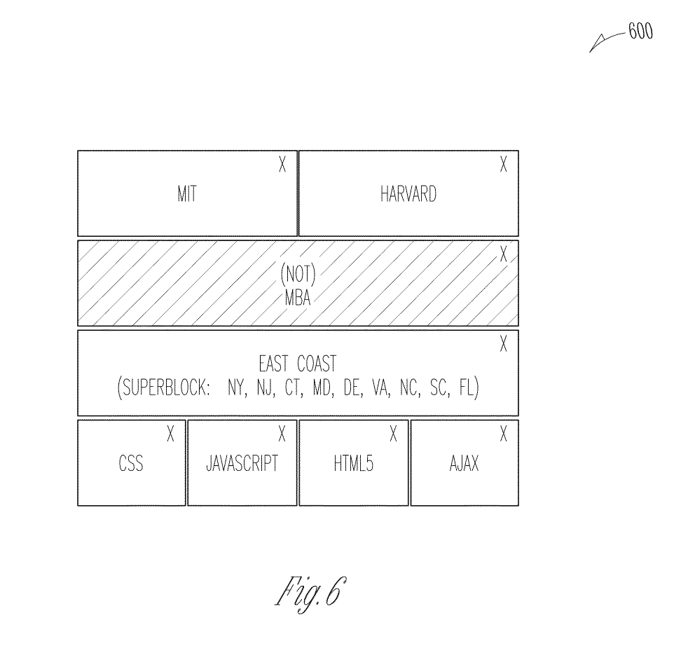

Accordingly, superblocks may be used to generate other superblocks. For example, the user interface 600 in FIG. 6 includes another search query string generated using another “east coast” superblock that specifies the various states of: “NY” OR “NJ” OR “CT” OR “MD” OR “DE” OR “VA” OR “NC” OR “SC” or “FL”. Thus, the greater social query string that the search query generation system 200 will generate based on the visual arrangement illustrated in FIG. 6 corresponds to: (“MIT” OR “Harvard”) AND (NOT(“MBA”)) AND (“NY” OR “NJ” OR “CT” OR “MD” OR “DE” OR “VA” OR “NC” OR “SC” or “FL”) AND (“CSS” OR “JavaScript” OR “HTML5” OR “AJAX”). In some embodiments, the user may click on a superblock, and a new window may open in the user interface displays the underlying visual arrangement and constituent icons in that superblock (e.g., for editing by the user).

In some embodiments, each of the icons may represent not only simple terms or words such as “MIT” or “Javascript”, but also attribute value pair such as “School=‘MIT’” or “Skill=‘Javascript’”, where a school or a skill may be an attribute that may be specified via a search engine. Accordingly, the search query generation system 200 may display a user interface enabling the user to specify a new icon (e.g., by selecting the new button 308 illustrated in FIG. 3) whereby the user may select from various dimensions or attributes (e.g., location, skills, title, industry, school, degree, profession, experience, etc.), and type in the appropriate value to generate the attribute-value pair and the associated icon (which may then be placed in window 301 in FIG. 3).

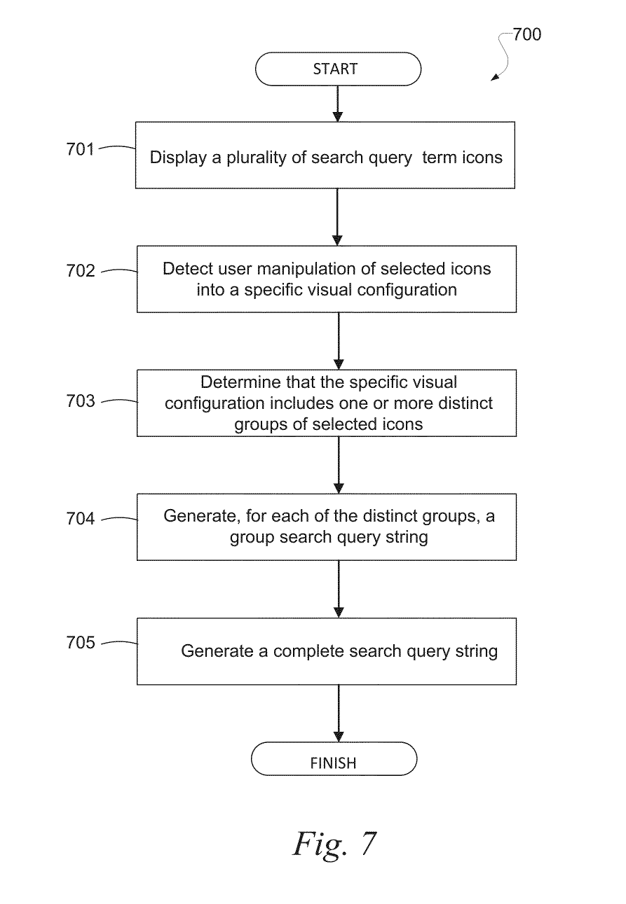

FIG. 7 is a flowchart illustrating an example method 700, consistent with various embodiments described above. The method 700 may be performed at least in part by, for example, the search query generation system 200 illustrated in FIG. 2 (or an apparatus having similar modules, such as one or more client machines or application servers). In operation 701, the user interface module 202 displays a plurality of search query term icons, also referred to herein as candidate search query term icons (e.g., see icons 303 FIG. 3) in a first user interface element (e.g., see window 301 in FIG. 3), each of the plurality of icons corresponding to a search query term. In operation 702, the user interface module 202 detects a user selection of one or more of the plurality of icons and a user manipulation of the selected icons into a specific visual configuration in a second user interface element (e.g., see icon 304 being dragged into window 302 in FIG. 3).

In operation 703, the user interface module 202 determines that the specific visual configuration includes one or more distinct lines or groups of the selected icons (e.g., the horizontal lines of icons in visual arrangement 401 in FIG. 4), wherein each of the distinct lines or groups includes one or more of the selected icons oriented in a first direction (e.g., the horizontal direction), and wherein the distinct groups are oriented in a second direction perpendicular to the first direction (e.g., the vertical direction).

In operation 704, the query generation module 204 generates, for each of the distinct lines or groups, a group search query string, each group search query string including the search query terms associated with the one or more selected icons in the respective group (e.g., MIT and Harvard in the first line/group in visual arrangement 401 in FIG. 4). Each group search query string may further include a first type of boolean search operator (e.g., an “OR” boolean search operator) between pairs of the search query terms included in the respective group search query string (e.g., (“MIT” OR “Harvard”) for the first line/group in visual arrangement 401 in FIG. 4).

In operation 705, the query generation module 204 generates a complete search query string that includes each of the group search query strings and further includes a second type of boolean search operator (e.g., an “AND” boolean search operator) between pairs of the group search query strings included in the complete search query string. It is contemplated that the operations of method 700 may incorporate any of the other features disclosed herein. Various operations in the method 700 may be omitted or rearranged, as necessary.

In some embodiments, the query generation module 204 may automatically insert (e.g., copy and paste) text associated with the complete search query string into a search query term input user interface element (e.g., a search bar) associated with a search engine. In some embodiments, the query generation module 204 may automatically perform a search, via a search engine, based on the complete search query string (e.g., after automatically inserting the complete search query string into a search query term input user interface element associated with the search engine).

In the examples described above, the first type of boolean search operator corresponds to an OR boolean search operator, and the second type of boolean search operator corresponds to an AND boolean search operator. However, in other embodiments, the first type of boolean search operator corresponds to an AND boolean search operator, and the second type of boolean search operator corresponds to an OR boolean search operator.

In some embodiments, the user interface module 202 may populate and rank the plurality of search query term icons into a list (e.g., see window/list 301 in FIG. 3), based on an historical utilization frequency value of each of the search query terms associated with each of the search query term icons. For example, the most commonly used icons (or icons for the most commonly used terms) may be placed higher in the list 301.

In some embodiments, the user interface module 202 may populate the list 301 with recommended or suggested search query terms for the user building the query. For example, before the user has selected any search query term icons from the list 301, the user interface module 202 may populate the list 301 with a set of search query term icons (e.g., the most frequently used search query term icons, as described above). Once the user has selected a search query term icon from the list 301, the user interface module 202 may identify frequently paired or frequently co-occurring terms with respect to the user selected term. For example, if the user selects term icon A (e.g., “MIT” or “School=‘MIT’”), the user interface module 202 may access historical log data of previous search queries in order to determine that user-selection of term icon A is usually followed by user-selection of term icons B1, B2, or B3 (e.g., “JAVA” or “Skill=‘Java’”). In other words, term icon A and term icons B1, B2, or B3 are frequently paired or frequently co-occurring terms. Thus, the user interface module 202 may populate the list 301 with all frequently paired or frequently co-occurring term icons B1, B2, or B3 for the term icon A that was selected by the user. Similarly, after the user selects term icon B1, the user interface module 202 may access historical log data of previous search queries in order to determine that user-selection of term icon B1 (or alternatively user-selection of term icon A followed by user-selection of term icon B1), is usually followed by user-selection of terms C1, C2, and C3, and the user interface module 202 may populate the list 301 with all frequently paired or frequently co-occurring term icons C1, C2, and C3. Thus, the system 200 suggests icons for frequently paired or frequently co-occurring terms as the user is building a visual search query.

In some embodiments, after the user has selected a search query term icon from the list 301, the user interface module 202 may identify similar terms or related terms with respect to the user selected term. For example, if the user selects the term icon “Industry=‘Internet’”, the user interface module 202 may access a list of related icons, such as “Skill=‘Javascript’”, and display such related icons in the list 301. Thus, the user interface module 202 may access information describing related icons from a database (e.g., database 208 in FIG. 2), in order to display icons in list 301 that are related to user-selected icons (and to prevent displaying unrelated icons in list 301 that are not related to user-selected icons).

In some embodiments, the user interface module 202 may display a free form text input field (similar to a search query bar), so that the user may input search terms via the text input field and the user interface module 202 will display matching search query term icons in the window 301. For example, if the user types the word “Michigan”, the user interface module may access a look-up table of known standardized keywords in order to match the word “Michigan” to the location “Michigan” or the school “University of Michigan”. Thereafter, the user interface module 202 may access or generate a search query term icon entitled “Michigan” that represents the keyword “Michigan” or the attribute-value pair “Location=‘Michigan’”, and a search query term icon entitled “University of Michigan” that represents the keywords “University of Michigan” or the attribute-value pair “School=‘University of Michigan’”, and include them in the list 301. In some embodiments, the aforementioned text input field may include a typeahead for standardized key words, where search query term icons for any terms ultimately selected by the user may be populated into the list 301. For example, if the user types in the keyword “Technology” in the text input field, the user interface module may display matches such as “Industry=‘Technology’” and “School=‘Massachusetts Institute of Technology’” as options in a pull down menu below the text input field. If the user selects “Industry=‘Technology’” in the aforementioned pull-down menu, then the corresponding search query term icon may be displayed in the list 301.

According to various example embodiments, the system 200 may perform the reverse process of converting a conventional Boolean search query into a visual representation that is described in various embodiments described herein. For example, the system 200 may display a free form text input field (similar to a search query bar), and the user may type or copy-and-paste into the text field a Boolean search query such as: (“MIT” OR “Harvard”) AND (NOT(“MBA”)) AND (“COMPUTER SCIENCE”) AND (“CSS” OR “JavaScript” OR “HTML5” OR “AJAX”). Thereafter, the system 200 may parse the query and generate the visual representation of the query in the user interface window 302 (e.g., see visual arrangement 401 in FIG. 4). For example, the query generation module 204 may identify groups of one more terms, where each of the groups are separated from one another by a first type of Boolean operator, and where the terms in a given group are separated from each other by a second type of Boolean operator. For example, the query generation module 204 may identify the following groups of one more terms, where each of the groups are separated from one another by an AND Boolean operator, and where any terms in a given group are separated from each other by an OR Boolean operator: (“MIT” OR “Harvard”), (NOT(“MBA”)), (“COMPUTER SCIENCE”), and (“CSS” OR “JavaScript” OR “HTML5” OR “AJAX”)). The query generation module 204 may then place icons for a given group of terms on the same line, with the different groups represented by separate adjacent lines, as illustrated in the visual arrangement 401 in FIG. 4.

In some embodiments, at least one of the search query terms is a word, such as “intern”. In some embodiments, at least one of the search query terms is an attribute-value pair (e.g., “Skill=‘HTML’”, “School=‘Harvard’”, “Position=‘Programmer’”, “Company=‘Apple’”, etc.).

In some embodiments, at least one of the search query terms is a saved complete search query string including one or more boolean search operators. For example, as described below, a complete search query string generated by the search query generation system 200 may be stored and associated with its own icon referred to herein as a “superblock” or search block icon, which may be manipulated in the same manner as other search query term icons.

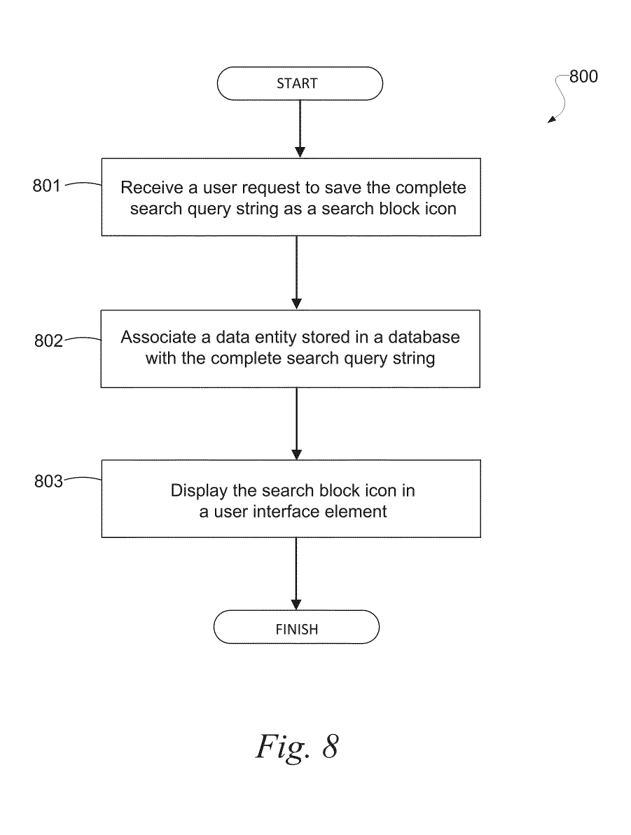

FIG. 8 is a flowchart illustrating an example method 800, consistent with various embodiments described above. The method 800 may be performed at least in part by, for example, the search query generation system 200 illustrated in FIG. 2 (or an apparatus having similar modules, such as one or more client machines or application servers). In operation 801, the user interface module 202 receives a user request to save the complete search query string as a search block icon (e.g., the user may select the save button 306 illustrated in FIG. 3). In operation 802, the query generation module 204 associates a data entity stored in a database (e.g., database 208 in FIG. 2) with the complete search query string. In operation 803, the user interface module 202 displays the search block icon in a user interface element (e.g., see the list of icons and the window 301 in FIG. 3), the search block icon being associated with the complete search query string and becoming a search query term icon. It is contemplated that the operations of method 800 may incorporate any of the other features disclosed herein. Various operations in the method 800 may be omitted or rearranged, as necessary.

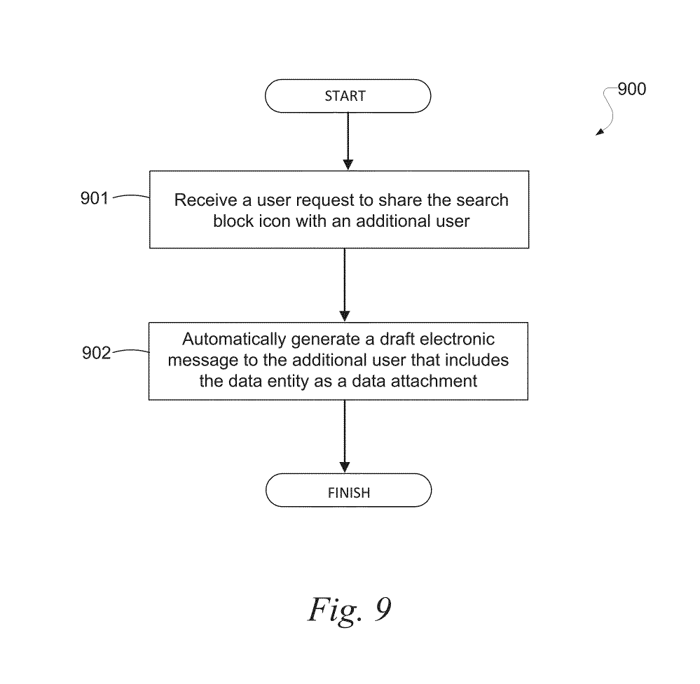

FIG. 9 is a flowchart illustrating an example method 900, consistent with various embodiments described above. The method 900 may be performed at least in part by, for example, the search query generation system 200 illustrated in FIG. 2 (or an apparatus having similar modules, such as one or more client machines or application servers). In operation 901, the user interface module 202 receives a user request to share a complete search query string and/or search block icon with an additional user (e.g., the user may select the share button 307 illustrated in FIG. 3). In operation 902, the user interface module 202 automatically generates a draft electronic message to the additional user that includes a data entity associated with the appropriate search block icon as a data attachment. It is contemplated that the operations of method 900 may incorporate any of the other features disclosed herein. Various operations in the method 900 may be omitted or rearranged, as necessary.

In some embodiments, the messages described herein may be any type of electronic message, including an e-mail, text message (e.g., a short messaging service (SMS) message, a multimedia messaging service (AAS) message, etc.), an instant message associated with an online social network (e.g., Facebook, LinkedIn, Wechat, WhatsApp, etc.), a chat message associated with an online chat service, a message being displayed directly in a user interface of the search query generation system 200, and so on.

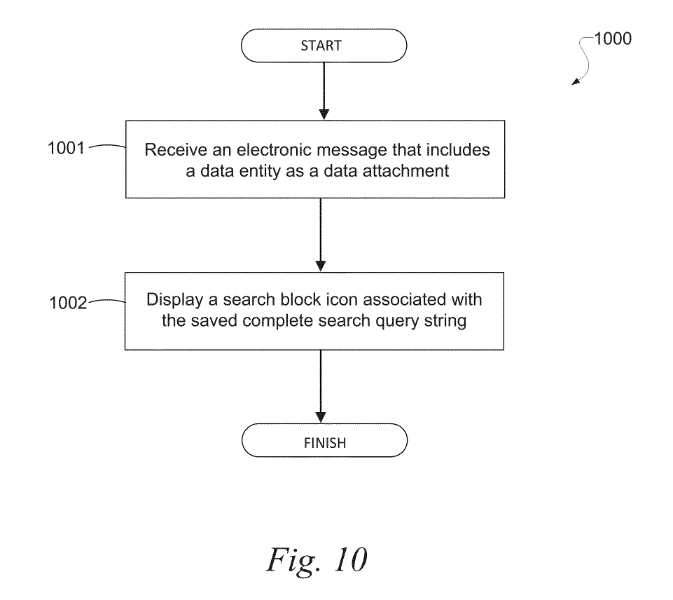

FIG. 10 is a flowchart illustrating an example method 1000, consistent with various embodiments described above. The method 1000 may be performed at least in part by, for example, the search query generation system 200 illustrated in FIG. 2 (or an apparatus having similar modules, such as one or more client machines or application servers). In operation 1001, the query generation module 204 receives an electronic message that includes a data entity as a data attachment, the data entity being associated with a saved complete search query string (e.g., associated with a superblock). In operation 1002, the user interface module 202 displays a search block icon associated with the saved complete search query string in a user interface element (e.g., see icons 303 in the window 301 illustrated in FIG. 3), the search block icon becoming a search query term icon. It is contemplated that the operations of method 1000 may incorporate any of the other features disclosed herein. Various operations in the method 1000 may be omitted or rearranged, as necessary.

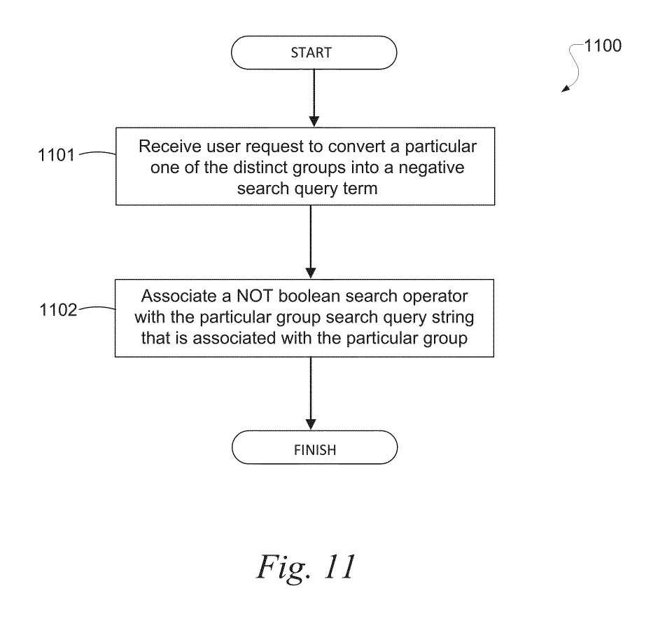

FIG. 11 is a flowchart illustrating an example method 1100, consistent with various embodiments described above. The method 1100 may be performed at least in part by, for example, the search query generation system 200 illustrated in FIG. 2 (or an apparatus having similar modules, such as one or more client machines or application servers). In operation 1101, the user interface module 202 receives a user request to convert a particular line/group of icons (e.g., (“MIT” OR “Harvard”) for the first line/group in visual arrangement 401 in FIG. 4) into a negative search query term. In operation 1102, the user interface module 202 associates a NOT boolean search operator with a particular group search query string in the complete search query that is associated with the particular group. It is contemplated that the operations of method 1100 may incorporate any of the other features disclosed herein. Various operations in the method 1100 may be omitted or rearranged, as necessary. In some embodiments, the user may indicate that a single icon should be associated with a negative Boolean logic operator (rather than an entire line/group of icons). Accordingly, the search query generation system 200 may associate a negative Boolean logic operator with the search query term associated with that icon, when generating the group search query string for that group/line.

### Example Mobile Device

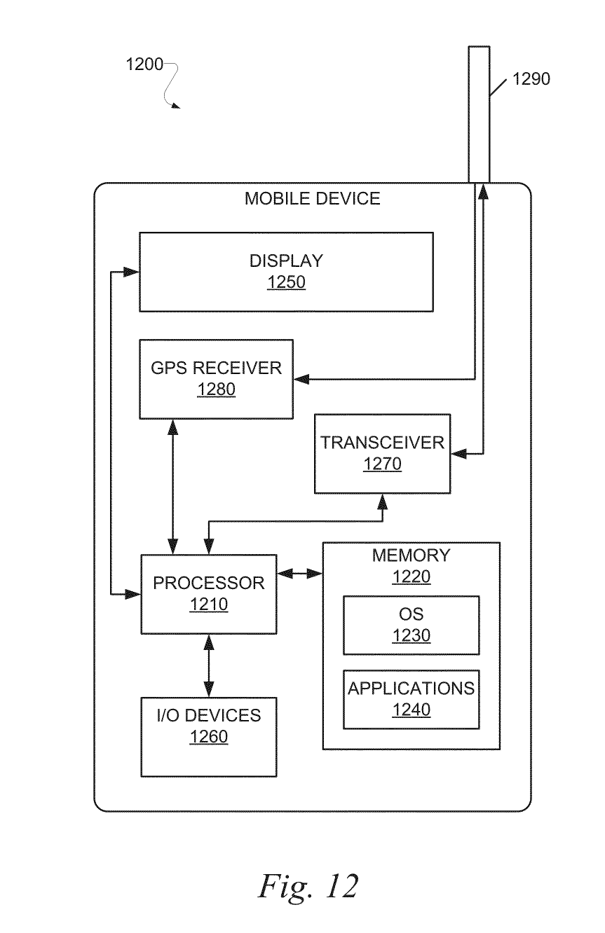

FIG. 12 is a block diagram illustrating the mobile device 1200, according to an example embodiment. The mobile device may correspond to, for example, one or more client machines or application servers. One or more of the modules of the system 200 illustrated in FIG. 2 may be implemented on or executed by the mobile device 1200. The mobile device 1200 may include a processor 1210. The processor 1210 may be any of a variety of different types of commercially available processors suitable for mobile devices (for example, an XScale architecture microprocessor, a Microprocessor without Interlocked Pipeline Stages (MIPS) architecture processor, or another type of processor). A memory 1220, such as a Random Access Memory (RAM), a Flash memory, or other type of memory, is typically accessible to the processor 1210. The memory 1220 may be adapted to store an operating system (OS) 1230, as well as application programs 1240, such as a mobile location enabled application that may provide location based services to a user. The processor 1210 may be coupled, either directly or via appropriate intermediary hardware, to a display 1250 and to one or more input/output (I/O) devices 1260, such as a keypad, a touch panel sensor, a microphone, and the like. Similarly, in some embodiments, the processor 1210 may be coupled to a transceiver 1270 that interfaces with an antenna 1290. The transceiver 1270 may be configured to both transmit and receive cellular network signals, wireless data signals, or other types of signals via the antenna 1290, depending on the nature of the mobile device 1200. Further, in some configurations, a GPS receiver 1280 may also make use of the antenna 1290 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

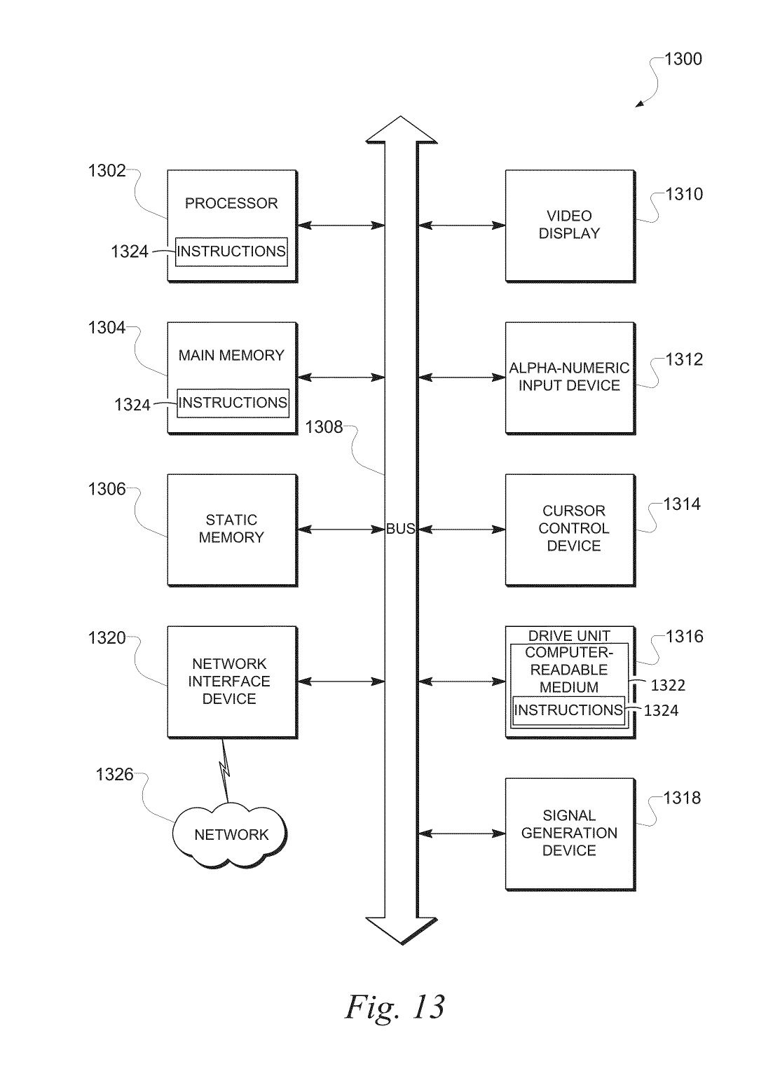

FIG. 13 is a block diagram of machine in the example form of a computer system 1300 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard or a touch-sensitive display screen), a user interface (UI) navigation device 1314 (e.g., a mouse), a disk drive unit 1316, a signal generation device 1318 (e.g., a speaker) and a network interface device 1320.

### Machine-Readable Medium

The disk drive unit 1316 includes a machine-readable medium 1322 on which is stored one or more sets of instructions and data structures (e.g., software) 1324 embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media.

While the machine-readable medium 1322 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1324 may further be transmitted or received over a communications network 1326 using a transmission medium. The instructions 1324 may be transmitted using the network interface device 1320 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
displaying a plurality of search query term icons in a first user interface element, each of the plurality of icons corresponding to a search query term;
detecting a user selection of one or more of the plurality of icons and a user manipulation of the selected icons into a specific visual configuration in a second user interface element;
determining that the specific visual configuration includes one or more distinct groups of the selected icons, wherein each of the distinct groups includes one or more of the selected icons oriented in a first direction, and wherein the distinct groups are oriented in a second direction perpendicular to the first direction;
generating, for each of the distinct groups, a group search query string, each group search query string including the search query terms associated with the one or more selected icons in the respective group and further including a first type of boolean search operator between pairs of the search query terms included in the respective group search query string; and
generating, using one or more processors, a complete search query string that includes each of the group search query strings and further includes a second type of boolean search operator between pairs of the group search query strings included in the complete search query string.

2. The method of claim 1, wherein the first type of boolean search operator corresponds to an OR boolean search operator, and wherein the second type of boolean search operator corresponds to an AND boolean search operator.

3. The method of claim 1, wherein the first type of boolean search operator corresponds to an AND boolean search operator, and wherein the second type of boolean search operator corresponds to an OR boolean search operator.

4. The method of claim 1, further comprising:
automatically inserting the complete search query string into a search query term input user interface element associated with a search engine.

5. The method of claim 1, further comprising:
automatically performing a search, via a search engine, based on the complete search query string.

6. The method of claim 1, wherein at least one of the search query terms is a word.

7. The method of claim 1, wherein at least one of the search query terms is an attribute-value pair.

8. The method of claim 1, wherein at least one of the search query terms is a saved complete search query string including one or more boolean search operators.

9. The method of claim 1, further comprising:
receiving a user request to save the complete search query string as a search block icon;
associating a data entity stored in a database with the complete search query string; and
displaying the search block icon in the first user interface element, the search block icon being associated with the complete search query string and becoming a search query term icon.

10. The method of claim 9, further comprising:
receiving a user request to share the search block icon with an additional user; and
automatically generating a draft electronic message to the additional user that includes the data entity as a data attachment.

11. The method of claim 1, further comprising:
receiving an electronic message that includes a data entity as a data attachment, the data entity being associated with a saved complete search query string; and
displaying a search block icon associated with the saved complete search query string in the first user interface element, the search block icon becoming a search query term icon.

12. The method of claim 1, further comprising:
receiving a user request to convert a particular one of the distinct groups into a negative search query term; and
associating a NOT boolean search operator with the particular group search query string in the complete search query that is associated with the particular group.

13. The method of claim 1, further comprising:
ordering the plurality of search query term icons in the first user interface element into a list, based on an historical utilization frequency value associated with each of the search query terms associated with each of the search query term icons.

14. A system comprising:
a user interface module, comprising one or more processors, configured to:
display a plurality of search query term icons in a first user interface element, each of the plurality of icons corresponding to a search query term;
detect a user selection of one or more of the plurality of icons and a user manipulation of the selected icons into a specific visual configuration in a second user interface element; and
determine that the specific visual configuration includes one or more distinct groups of the selected icons, wherein each of the distinct groups includes one or more of the selected icons oriented in a first direction, and wherein the distinct groups are oriented in a second direction perpendicular to the first direction; and
a query generation module, comprising the one or more processors, configured to:
generate, for each of the distinct groups, a group search query string, each group search query string including the search query terms associated with the one or more selected icons in the respective group and further including a first type of boolean search operator between pairs of the search query terms included in the respective group search query string; and
generate a complete search query string that includes each of the group search query strings and further includes a second type of boolean search operator between pairs of the group search query strings included in the complete search query string.

15. The system of claim 14, wherein the first type of boolean search operator corresponds to an OR boolean search operator, and wherein the second type of boolean search operator corresponds to an AND boolean search operator.

16. The system of claim 14, wherein the query generation module is further configured to:
automatically insert the complete search query string into a search query term input user interface element associated with a search engine.

17. The system of claim 14, wherein the user interface module is further configured to receive a user request to save the complete search query string as a search block icon, and
wherein the query generation module is further configured to associate a data entity stored in a database with the complete search query string, and
wherein the user interface module is further configured to display the search block icon in the first user interface element, the search block icon being associated with the complete search query string and becoming a search query term icon.

18. A non-transitory machine-readable storage medium comprising instructions that, when executed by one or more processors of a machine, cause the machine to perform operations comprising:
displaying a plurality of search query term icons in a first user interface element, each of the plurality of icons corresponding to a search query term;
detecting a user selection of one or more of the plurality of icons and a user manipulation of the selected icons into a specific visual configuration in a second user interface element;
determining that the specific visual configuration includes one or more distinct groups of the selected icons, wherein each of the distinct groups includes one or more of the selected icons oriented in a first direction, and wherein the distinct groups are oriented in a second direction perpendicular to the first direction;
generating, for each of the distinct groups, a group search query string, each group search query string including the search query terms associated with the one or more selected icons in the respective group and further including a first type of boolean search operator between pairs of the search query terms included in the respective group search query string; and
generating, using one or more processors, a complete search query string that includes each of the group search query strings and further includes a second type of boolean search operator between pairs of the group search query strings included in the complete search query string.

19. The storage medium of claim 18, wherein the first type of boolean search operator corresponds to an OR boolean search operator, and wherein the second type of boolean search operator corresponds to an AND boolean search operator.

20. The storage medium of claim 18, further comprising:
automatically inserting the complete search query string into a search query term input user interface element associated with a search engine.
